(19) United States
(12) Patent Application Publication
(10) Pub. No.: US 2018/0113297 A1
(43) Pub. Date: Apr. 26, 2018

(54) Active droplet transport defogging

(71) Applicants: Amish Desai, Altadena, CA (US); Michael Emerling, South Pasadena, CA (US); Nathaniel Selden, La Habra, CA (US); Stephen Chau, San Gabriel, CA (US); Robert Melendes, Monrovia, CA (US)

(72) Inventors: Amish Desai, Altadena, CA (US); Michael Emerling, South Pasadena, CA (US); Nathaniel Selden, La Habra, CA (US); Stephen Chau, San Gabriel, CA (US); Robert Melendes, Monrovia, CA (US)

(73) Assignee: Tanner Research, Inc., Monrovia, CA (US)

(21) Appl. No.: 15/330,637

(22) Filed: Oct. 21, 2016

(51) Int. Cl. G02B 26/00; G02B 27/00

(52) U.S. Cl. CPC G02B 26/005; G02B 27/0006

(57) ABSTRACT

A system and method for facilitating removal of condensation from an optic surface. An example Active Droplet Transport (ADT) system includes a transparent ElectroWetting (EW) circuit positioned on or within an optic; a controller (also called a drive circuit) in communication with the EW circuit; and instructions implemented by the controller and configured to selectively activate the transparent EW circuit to remove condensation from a surface of the optic.

### CROSS REFERENCE TO RELATED PATENT

This application claims priority from U.S. Provisional Patent Application, Ser. No. 62/285,216, entitled ACTIVE DROPLET TRANSPORT DEFOGGING, filed on Oct. 21, 2016, which is hereby incorporated by reference as if set forth in full in this application for all purposes.

### BACKGROUND

The present application relates to defogging and anti-fogging mechanisms and systems, and more specifically to systems and methods employing electronics to facilitate defogging of surfaces and/or prevention of problematic fog (e.g., condensation) from occurring on the surfaces, including, but not limited to, optics or other transparent or partially transparent and/or reflective surfaces.

Defogging mechanisms are employed in various demanding applications including ski goggles, swim goggles, glasses, helmet optics (e.g., visors and shields), automobile windows, mirrors, microscopes, scuba diving or snorkeling masks, telescopes, binoculars, camera lenses, virtual reality and augmented reality goggles and headsets, and other eyewear and surfaces for which condensation or excess humidity can be problematic. Such applications often demand efficient mechanisms for preventing condensation (i.e., fogging) on optic surfaces and/or enabling rapid and relatively complete removal of surface condensation before the condensation becomes problematic.

Conventionally, anti-fogging mechanisms for optical surfaces may include surfactant films, hydrophilic surface structures, sprays, creams, gels, strategic colloid or nanoparticle solutions, and so on. Alternative defogging mechanisms include heaters embedded in the optics to facilitate evaporation of condensation from the surfaces; mechanisms for diverting airflow over surfaces so as to facilitate fog evaporation, and so on.

However, such conventional anti-fogging or defogging mechanisms are often inefficient and fail to rapidly and/or completely prevent optic surface condensation and/or fail to enable active removal of existing condensation. For example, heater wires embedded in optics (e.g., automobile windows) often slowly and/or partially defog portions of the optic surfaces, e.g., coinciding with the locations of heater elements embedded in the optics. In addition, such mechanisms can be energy-inefficient, and require large power sources for long duration operation. Furthermore, repeated heating cycles may reduce the longevity of some types of optics substrate materials, e.g., certain transparent polymers, and can result in the ageing (cracking/delamination) of the electrodes themselves.

### SUMMARY

An example system facilitates removal of condensation from an optic surface, including small seedling condensation, and may further be configured to prevent problematic condensation from initially occurring on the optic surface. The example system includes a transparent ElectroWetting (EW) circuit positioned on or within an optic; a controller (also called a drive circuit) in communication with the electrowetting circuit; and code (e.g., as may be expressed using Hardware Description Language (HDL), a finite state machine, simple repetitive hard-coded waveform, etc.) running on or as the controller and configured to selectively activate the transparent EW circuit (or portions thereof) to remove condensation from a surface of the optic.

In a more specific embodiment, the transparent EW circuit includes a microfluidic transparent EW circuit. Optionally, a fog sensor detects condensation (i.e., fogging) on the optic surface and generates a sensing signal in response thereto. The computer code includes instructions for selectively activating the transparent microfluidic EW circuit based on and/or in response to the sensing signal.

In the specific embodiment, the optic surface represents a non-PCB surface. The optic surface includes a curved surface. The transparent microfluidic EW circuit includes a circuit constructed using electrode deposition using a flexible or ridged mask for patterning transparent electrodes of the transparent microfluidic EW circuit onto a film or directly onto the optic surface. The film and accompanying transparent microfluidic EW circuit may then be disposed on an optic substrate to facilitate removal of optic surface fog and/or to prevent substantial accumulation of the surface fog on the film surface and/or an accompanying protective and/or surfactant coating.

Note that in general, conventional anti-fog mechanisms do not employ electrowetting or active droplet techniques to remove condensation from a non-PCB (Printed Circuit Board) surfaces using transparent electrodes; nor do they involve use of EW phenomena to defog optics; nor do they involve use of the EW phenomena to defog curved surfaces. Certain embodiments discussed herein employ efficient mechanisms and methods (e.g., use of flexible membrane masks and films, as discussed herein) for transferring transparent electrodes to optical surfaces, including curved optical surfaces, for use in EW defogging embodiments discussed herein.

Conventionally, EW circuits are often limited to use on PCB substrates; or in fluid-filled lens applications that selectively distort encapsulated water droplets to affect lens optical properties; in electrically tunable optical switches; or for general microfluidic chip applications.

Accordingly, use of transparent microfluidic EW circuits and accompanying circuit controllers in accordance with embodiments discussed herein, may enable low power, yet rapid and efficient defogging of optics, which can greatly improve functionality of cycwcai and other optics, where surface condensation can be problematic.

### BRIEF DESCRIPTION OF THE DRAWINGS

FIG. 1 is a block diagram illustrating a first example ElectroWetting (EW) anti-fog system and accompanying optic.

FIG. 2 shows an example transparent anti-fog electrowetting circuit, characterized by a first example electrode pattern, at various stages of defogging of an accompanying optic surface using Active Droplet Transport (ADT).

FIG. 3 shows a series of graphs illustrating example EW circuit drive electrode activation patterns for various operational modes, wherein properties (e.g., voltage levels, activation durations, etc.) of the different operational modes may be tuned for transporting droplets of different sizes or ranges of sizes across the surface of an optic.

FIG. 4 shows a second example EW circuit electrode pattern, suitable for use with the EW circuit of FIG. 1, and which includes drive electrodes exhibiting a symmetric comb pattern.

FIG. 5 shows a third example EW circuit electrode pattern, which includes drive electrodes exhibiting a staggered comb pattern, with ground electrodes that are interspersed with and that run parallel to the drive electrodes.

FIG. 6 shows a fourth example EW circuit electrode pattern, which includes drive electrodes exhibiting relatively narrow spacing gaps (relative to line widths of the drive electrodes).

FIG. 7 shows a sixth example EW circuit electrode pattern, which includes drive electrodes exhibiting interdigitated triangles.

FIG. 8 shows a seventh example EW circuit electrode pattern, which includes drive electrodes exhibiting tight-mesh interdigitated triangles.

FIG. 9 shows an eighth example EW circuit electrode pattern, which includes drive electrodes exhibiting a graduated line with pattern.

FIG. 10 is a flow diagram of a first example method suitable for use with the system of FIG. 1 for removing fog from an optic surface.

FIG. 11 is a diagram of a second example method suitable for use with the system of FIG. 1 for using EW circuit electrodes for surface fog sensing, which is not necessarily limited to fog sensing on optic surfaces.

FIG. 12 is a diagram of a third example method suitable for use with the embodiments of FIGS. 1 and 2 for applying an electrode activation wave to an array of drive electrodes of an EW circuit, and which is not necessarily limited to use in combination with an optic surface.

### DETAILED DESCRIPTION OF EMBODIMENTS

For the purposes of the present discussion, an optic may be any transparent or partially transparent or reflective material suitable for viewing items there through or reflected therefrom. Examples of optics include corrective lenses, protective lenses for.harsh or hazardous environmental work, sunglass lenses, scuba diving mask lenses, ski google lenses, aircraft helmet visors or viewing windows, mirrors, telescope lenses, microscope lenses, and so on. Similarly, an optic surface (also called optical surface) may be any surface of an optic.

A defogging mechanism may be any mechanism that enables removal of fog or condensation from a surface, such as an optic surface. Note that the term “fog” or “fogging” may refer to any moisture, e.g., condensation, occurring on a surface, where the moisture (e.g., liquid) resembles fog when the surface is looked through or looked at. Hence, in general, for the purposes of the present discussion, fog may be any visible moisture or liquid on a surface that obscures or partially obscures a transparent or reflective portion of the optic. Note however, that the term “fog” as applied to solar panel surfaces or other non-optic surfaces may represent any moisture on a surface, which may include but is not limited to, liquid that partially obscures (or blocks or partially blocks) detectors or other features and/or functionality of interest.

Accordingly, condensation of a gas or vapor into a liquid onto a surface, e.g., optic surface, represents a type of fog, but not the only type of fog that may be removed from a surface using embodiments disclosed herein. Note that water vapor may change state from a gas into liquid water when in contact with a surface having a temperature below the dew point of the gas.

Similarly, an antifogging mechanism may be any mechanism for facilitating prevention of problematic fog or condensation from coalescing on a surface. Accordingly, a defogging mechanism may also be an anti-fogging mechanism if the defogging mechanism is used to maintain a surface substantially free of condensation or fog, or if the defogging mechanism is used to remove condensation or fog prior to such condensation becoming noticeable or degrading the optic system.

A transparent material may be any material that is fully or partially transparent to the optical band of electromagnetic energy. For the purposes of the present discussion, the wavelength of electromagnetic energy in the “optical band” may comprise electromagnetic energy exhibiting wavelengths between approximately 200 and 1500 nanometers. In general, transparent optic surfaces discussed herein will exhibit a transmissivity of greater than approximately 10%.

Note that depending upon the context in which the term “optic surface” (also called “surface of an optic”) is used, the term may be taken to include one or more layers (on or adjacent to inside and/or outside surfaces) on an outermost portion of an optic or may be taken to include just an outermost surface of the optic. For the purposes of the present discussion, an outermost surface of an optic may be any optic surface that faces toward or is exposed to the elements or otherwise faces outwardly from an optic substrate underlying the surface, such that, for example, optic surfaces of goggles that are closest to the eyes of the wearer may represent outermost surfaces despite the surfaces being interior to the goggles. Accordingly, in certain instances, a circuit embedded near an outermost surface of an optic may be considered to be disposed on a surface of the optic or on a surface of a substrate material of the optic. Note that embodiments are not limited to mechanisms disposed on an optic surface, but may include, for example, circuits embedded within optics, e.g., sandwiched between glass (or other substrate material) layers of the optic.

For clarity, certain well-known components, such as memory storage devices, processors, power supplies, current and voltage circuit drivers, and so on, are not necessarily explicitly called out in the figures. However, those skilled in the art with access to the present teachings will know which components to implement and how to implement them to meet the needs of a given implementation.

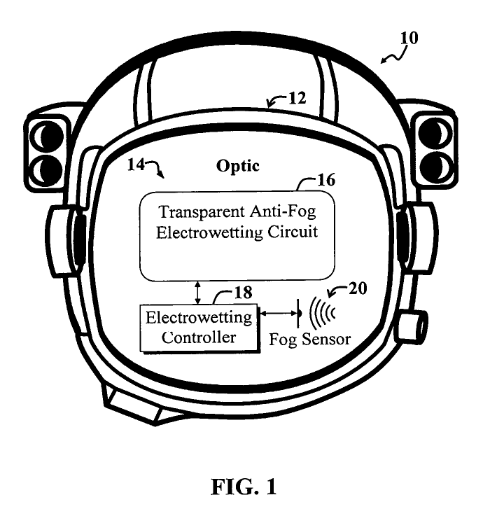

FIG. 1 is a block diagram illustrating a first example ElectroWetting (EW) anti-fog system 14, also called an Active Droplet Transport (ADT) system, used with an example helmet 10 and accompanying optic 12 (e.g., helmet visor, shield, or lens). The optic 12 may comprise glass or other transparent or partially transparent material, e.g., polycarbonate.

For the purposes of the present discussion, electrowetting may be any modification of one or more wetting properties of a surface using an electric field. An EW circuit may be any circuit used to apply the electric field to the surface to facilitate affecting the wetting properties of the surface. Note that, in certain embodiments discussed herein, the electric field is dynamic and/or differential.

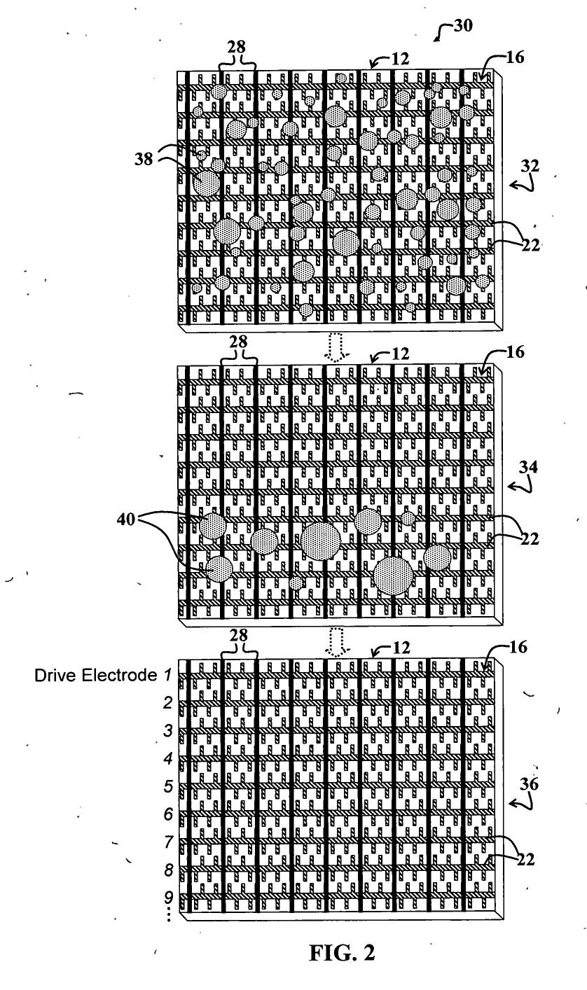

The example anti-fog system 14 includes an EW controller 18 that selectively drives a transparent EW circuit 16 that extends across or otherwise covers a selected viewable portion of the optic 12, i.e., is positioned on or embedded in or near a viewable region, i.e., aperture, of the optic 12. The EW circuit 16 represents a microfluidic EW circuit that employs transparent electrodes to selectively shuttle or move surface condensation, including very small seedling condensation (e.g., droplets of less than 25 microns in diameter) occurring on the optic 12 away from the viewable area of the optic 12 and/or away from another area of the optic from which condensation removal is desired. Small seedling condensation is typically aggregated into larger droplets as the condensation is shuttled from the surface, as discussed more fully below with reference to FIG. 2.

Note that the optic 12 and accompanying interior and exterior optic surfaces represent so-called non-PCB surfaces. For the purposes of the present discussion, a non-PCB surface may be any surface that is not a substantially planar rigid polymer or silicon surface conventionally used for accommodating a circuit disposed thereon. Examples of non-PCB surfaces include glass or transparent polymer surfaces of windows of automobiles or buildings, lenses (e.g., eyewear lenses), and so on.

For the purposes of the present discussion, the term “transparent electrodes” may include any electrically conductive material (e.g., conductive polymer) that is sufficiently sized, arranged, or otherwise constructed to enable a viewer to see through or partially through a circuit that comprises the electrodes. In certain implementations, electrode material itself may be opaque, but the electrode line widths may be sufficiently small, and the electrodes may be sufficiently spaced such that when disposed on an optic surface, the optic surface remains transparent. In certain embodiments, ultra-fine electrodes (e.g., less than 25 micron line widths with varying pitch) may be strategically constructed to additionally provide a type of optic tinting.

In the present example embodiment, the EW controller 18 communicates with a fog sensor 20, which is adapted to sense initiation of problematic fog occurring on a surface of the optic 12, i.e., optic surface. The sensor 20 may measure transmissivity of the optic 12, and/or may measure humidity and temperature in the vicinity of the optic surface 12 and the temperature of the optic to generate a prediction of the likelihood of fog occurring on the interior and/or exterior surface of the optic 12.

Note that the fog sensor 20 may measure optic obscuration and/or to sense the fog using the actual EW circuit electrodes, e.g., by sending signal through the circuit 16 and measuring the responsive output signal. Fog on the surface of the optic can alter the transfer function of the circuit 16 (e.g., by affecting circuit capacitance), as discussed more fully below. Such alterations can be mapped to different fog levels, the levels of which can in turn be selectively associated with different driving waveforms, i.e., electrode activation patterns.

Note that details pertaining to implementation of the fog sensor 20 may be implementation specific and may vary, without departing from the scope of the present teachings. For example, in certain implementations, the fog sensor 20 may be implemented as a micro camera that sends imagery to the controller 18, which may run an algorithm for matching the imagery from the micro camera with different previously stored imagery that has been pre-associated with certain fog levels. The controller 18 may then determine that the current fog state is the state that represents the closest match between imagery output from the fog sensor 20 and predetermined fog levels associated with the previously stored imagery used for comparisons.

In other implementations, the fog sensor 20 and/or associated functionality may be entirely omitted. For example, in certain implementations, the EW controller 18 may be activated via a button or other mechanism when the user of the optic 12 wishes to remove fog from the optic 12. In other implementations, the controller 18 may be implemented via an always-on finite state machine that selectively issues a sequence of fog-removing drive signals to the EW circuit 16. The EW controller 18 may cycle through various drive signals tuned to remove various droplet sizes from the surface of the optic 12

In summary, in embodiments lacking the fog sensor 20, the EW controller 18 may continuously, periodically, and/or otherwise selectively drive the transparent anti-fog EW circuit 16, e.g., using a simple repeating drive waveform.

In the present example embodiment, the sensor 20 outputs a signal that is readable by the EW controller 18, such that the EW controller 18 can determine when and how (e.g., with which driving waveform) to activate the transparent microfluidic anti-fog EW circuit 16 disposed on the surface of the optic 12. For example, the EW controller 18 may associate different fog-level thresholds with different specialized waveforms, as discussed more fully below.

For the purposes of the present discussion, a microfluidic circuit may be any circuit for affecting movement of fluid, e.g., water droplets, where the circuit includes one or more features or components with one or more dimensions that are on the order of sub-micron to hundreds of microns in size.

Hence, the example system 14 represents a system for facilitating removal of condensation, i.e., fog, from a surface, the system 14 including a transparent EW circuit 16 positioned on or within an optic 12; a controller 18 (i.e., drive circuit) in communication with the EW circuit 18; and computer code (e.g., software, firmware, and/or hardware instructions) running on or as the controller 18 and configured to selectively activate the transparent EW circuit 16 to remove condensation from a surface of the optic 16.

For the purposes of the present discussion, computer code may refer to any set of one or more machine-readable instructions, where a machine may be any circuit, e.g., processor or other mechanism, for reading or interpreting the instructions. Accordingly, instructions implemented in hardware, e.g., via a finite state machine or other circuit, may represent a type of computer code for the purposes of the present discussion.

Furthermore, note that in certain implementations, the controller 18 and associated instructions or mechanisms may be implemented via one or more simple oscillators for driving the EW circuit 16 with one or more electronic waveforms suitable to remove fog from the optic 12, without departing from the scope of the present teachings.

The transparent EW circuit 16 represents a microfluidic transparent EW circuit that includes the fog sensor 20 for detecting condensation on the surface of the optic 12 and generating a sensing signal in response thereto. The computer code running on the EW controller 18 includes instructions for selectively activating the transparent microfluidic EW circuit 16 based on (or in response to) the signal.

Note that the optic 12 may exhibit curved interior and exterior surfaces, one of which or both of which may be curved surfaces exhibiting the transparent microfluidic EW circuit 16 disposed thereon or therein. The EW circuit 16 may be disposed on one or more surfaces of the optic 12 via electrode deposition or other electrode patterning techniques or methods. Alternatively or in addition, the EW circuit 16 may be built into a transparent film that is then applied to the optic 12.

The electrodes that comprise the EW circuit 16 may be constructed from transparent or partially transparent conductive or partially conductive materials, such as graphene, Indium-Tin Oxide (ITO), carbon nano-tubes (CNTs), and conductive elastomer or polymers. For certain implementations, some advantages may be afforded when using elastomeric or polymeric conductive materials that are able to withstand stretching and bending.

FIG. 2 shows an example transparent anti-fog EW circuit 16 (comprising a first example pattern of drive electrodes 22 and ground electrodes 28, where the drive electrode pattern is called a staggered comb pattern) and accompanying optic 12 at various stages 30 (comprising stages 32-36) of defogging of an accompanying optic using Active Droplet Transport (ADT).

For the purposes of the present discussion, ADT may be any process that uses a controlled (e.g., selectively driven) electric field (e.g., dynamic electric field) to leverage EW phenomena to move condensed fluid (e.g., water) droplets off of a surface, e.g., through selective (e.g., strategically pulsed) voltage and/or current waveforms applied to distributed drive electrodes 22 on or embedded in (e.g., in a surface region and/or layer) of an optic to be defogged.

In the present example embodiment, the ground electrodes 28 run substantially perpendicular to the staggered-comb drive electrodes 22 and are separated from the staggered-comb drive electrodes 22 by a transparent insulating dielectric, resulting in an EW circuit 16 with dual layers (i.e., one layer for the activation electrodes 22, and another layer for the ground electrodes 28, resulting in so-called dual-layer electrodes 22, 28). Note that embodiments are not necessarily limited to EW circuits with dual layers, but instead may involve use of coplanar electrodes with voltages that are selectively set to enable, for example, establishment of a sufficient electric field between an electrode and a droplet that is electrically coupled to another nearby electrode to trigger desired movement of the droplet. Furthermore, note that while the example EW circuit 16 of FIG. 2 exhibits ground electrodes 28 that are substantially perpendicular to the activation electrodes 22, that embodiments are not limited thereto. In the present example embodiment, the ground electrodes 28 are positioned above the drive electrodes 22 and are exposed (e.g., electrically exposed such that electrical contact is enabled between the ground electrodes 28 and one or more fog droplets 38) on the surface of the optic 12 and may be in electrical contact with fog droplets 38 thereon (e.g., through a leaky dielectric therebetween, the leaky dielectric of which may be used to coat the ground electrodes 28). Furthermore, note that, for the purposes of the present discussion, two things are in electrical contact if a conductive path exists therebetween that allows electrical current to flow therebetween. Accordingly, the fog droplets are said to be grounded from below by the ground electrodes 28 (e.g., as opposed to grounded from above using a separate grounding sheet or plane used to sandwich droplets between a channel in which the droplets are moved between the sheet and a substrate).

When a voltage is applied to one or more of the drive electrodes 22, this results in an electric field between the activated drive electrodes 22 and any nearby droplets 38 (which can be grounded or approximately grounded). The electric field causes a difference in surface tension between opposite sides of nearby droplets 38, thereby causing them to move across the surface of the optic 12. By selectively activating the drive electrodes 22 (e.g., by applying a voltage and/or current thereto), individually or in selective groups, different sized droplets can be effectively moved on the surface of the optic 12 in a direction determined by the drive-electrode activation pattern, as diccussed more fully below.

With reference to FIGS. 1 and 2, the various stages 30 include an initial fogged state 32 of the optic 12; a partially defogged state 34 after activation of the electrowetting controller 18 of FIG. 1; and a completely defogged state 36 after completion of defogging of the optic 12. Note that in certain implementations, optic surfaces need not be completely defogged, but may be partially defogged, without departing from the scope of the present teachings. Accordingly, embodiments are not limited to complete defogging applications.

In the initial fogged state 32, a surface of the optic 12 is covered with various small droplets 38 of varying sizes, which may include micro droplets on the scale of micrometers and/or smaller. The transparent or partially transparent anti-fog EW circuit 16 of FIG. 1 is shown in FIG. 2 as comprising an array of transparent or partially transparent electrodes 22, 28.

Note that for illustrative purposes, the various electrodes 22, 28 are shown as visible, but that in practice, the electrodes 22, 28 may be substantially invisible or barely visible. However, embodiments are not necessarily limited to transparent electrodes or ADT on optic surfaces. Those skilled in the art will appreciate that unique electrode driving methods; flexible films fitted with EW circuits; use of the EW circuit 16 for both fog sensing and removal, and so on, as discussed herein and more fully below, may be suitable for various applications not limited to optics.

The EW controller 18 of FIG. 1 selectively applies voltage waveforms to the drive electrodes 22 (also called signal electrodes) to trigger merging and transporting of the droplets 38 existing in the initial state 32.

After initial activation of the EW controller 18, the initial droplets 38 are transported across and eventually removed off of the optic 12, resulting in the second state 34, where only a few relatively larger merged or aggregated droplets 40 remain on the optic 12. In the present example embodiment, the drive electrodes 22 have been activated in a pattern sufficient to shuttle the droplets 38 downward across the surface of the optic 12.

Finally, after complete defogging, the third state 36 illustrates absence of condensation droplets, i.e., fog, on the surface of the optic 12.

In summary, ADT as discussed herein may utilize the physical phenomena of EW to move condensed droplets off of a surface through voltage or current waveforms applied to embedded electrodes in, on, or otherwise near the surface of an optic or flexible transparent film, e.g., as may disposed on the optic or other type of surface or substrate.

For the purposes of the present discussion, a flexible film may be any film or skin that includes electronics and/or electrodes that are sufficiently pliable and/or deformable, e.g., to allow for the placing of the EW electrodes onto curved surfaces, such as the surface of a spherical lens. This is distinctly different from conventional stiff electronics that are fabricated on silicon, PCB, or glass substrates, etc.

Embodiments have been constructed and tested using glass substrates (as well as flexible films) supporting the anti-fog EW circuit drive electrodes 22 (where nine example drive electrodes are shown in FIG. 2) and ground electrodes 28. Furthermore, these electrodes 22, 28 can be fabricated using transparent metals and may also be fabricated on or embedded in flexible skins (also called flexible films herein), thereby allowing for application of the electrodes 22, 28 onto curved surfaces, such as eyewear lenses.

Power consumption calculations show that such embodiments can be operated continuously for time periods well in excess of twenty-four hours using a relatively small battery that may be concealed or partially concealed or otherwise accommodated within a helmet structure or eyewear frame or strap.

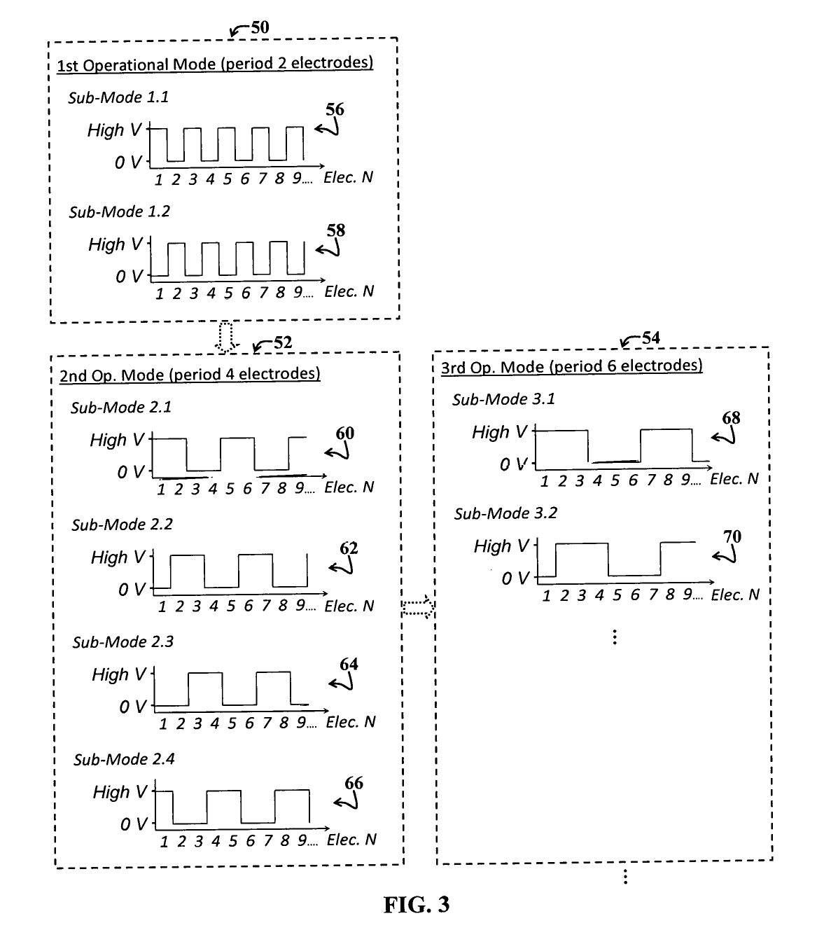

FIG. 3 shows a series of graphs 56-70 illustrating example EW circuit drive electrode activation patterns for various operational modes 50-54, wherein properties (e.g., voltage levels, activation durations, etc.) of the different operational modes 50-54 may be tuned for transporting droplets of different sizes or ranges of sizes across the surface of an optic in a direction determined by the associated electrode activation pattern.

FIG. 3 illustrates three example operational modes 50-54, each including plural electrode activation states, which represent sub-modes of the associated operational modes 50-54. For example, a first operational mode 50 includes a first activation state 56 (labeled sub-mode 1.1) represented in graph form, where individual drive electrodes are numbered 1-9 along the horizontal axis, and voltage level is indicated on the vertical axis.

In the first activation state 56, every other drive electrode is activated with a high voltage state, e.g., 40V, starting with the first drive electrode (1) being activated, the second drive electrode (2) being grounded (or set to another lower voltage state, e.g., negative voltage state), the third drive electrode (3) being activated, and so on. Note that the exact voltage levels that are representative of high (i.e., activated) and low (deactivated) voltage states are implementation specific and may vary depending upon the needs of a given implementation. Furthermore, note that while the activation state 56 (operational sub-mode 1.1) is illustrated for nine example drive electrodes, that the actual number (N) may vary depending upon the needs of a given implementation.

In a second activation state 58 (operational sub-mode 1.2) of the first operational mode 50, electrodes (1, 3, 5, 7, 9) that were previously activated in the first state 56 are deactivated (e.g., grounded or otherwise set to a low voltage state), and the deactivated electrodes (2, 4, 6, 8) of the first state 56 are activated in the second state 58.

Note that the first activation state 56 and second activation state 58 may be held on for a predetermined time interval (e.g., on the order of 100's of microseconds or 100's of milliseconds) before cycling to the next state. During the first operational mode 50, the sub-modes or states 56, 58 may be cycled, such that the first state 56 is applied, followed by the second state 58, followed by the first state 56, and so on.

The exact number of cycles through sub-modes of a given operational mode are implementation specific and may vary, without departing from the scope of the present teachings. For example, in certain implementations, the first sub-mode 56 and second sub-mode 58 are only implemented once before the process moves to the second operational mode 52. In other implementations, the sub-modes 56, 58 will be cycled several times before the second operational mode 52 is implemented.

Note that cycling between sub-modes (e.g., sub-modes 56, 58) results in an electrode activation pattern, also called a geometric wave or electrode activation wave. In the first operational mode 50, the geometric wave is said to have a period of two electrodes, consistent with the graphs representing the sub-modes 56, 58. The first operational mode 50 is suitable for shuttling or moving relatively small droplets across a surface in a direction of the activation pattern (geometric wave), which in this example case is parallel to the ground electrodes 28 of FIG. 1.

After implementation of the period-two electrode activation pattern 56, 58 of the first operational mode 50, the second operational mode 52 is implemented. The second operational mode 52 represents a period-four electrode activation pattern, and includes four electrode activation states, i.e., sub-modes 60-66 (also labeled sub-modes 2.1-2.4).

In the first sub-mode 60 (2.1), electrodes are activated in alternate pairs, such that the first two drive electrodes (1, 2) are set to a high voltage state, while the adjacent two drive electrodes (3, 4) are set to a low voltage state (e.g., 0V or ground).

During the second sub-mode 62 (2.2), the electrode activation state is shifted by one, such that now electrodes 2, 3 are activated, and the adjacent electrodes 4, 5 are deactivated, and so on.

The process continues in the third sub-mode 64, such that now electrodes 3, 4 are activated and electrodes 5, 6 are deactivated, and so on.

Similarly, in the fourth sub-mode 66, electrodes 4, 5 are activated and electrodes 6, 7 are deactivated, and so on. After the fourth sub-mode 66, one cycle of the period-4 electrode pattern is complete, and the activation state returns to the first sub-mode 60 (2.1). The completion of one cycle of the period-4 electrode pattern represents completion of one wave of the geometric wave characterizing the second operational mode 52.

Note that the second operational mode 52 may be suitable for efficiently transporting relatively large fog droplets (as compared to the droplets efficiently transported during the first operational mode 50). Furthermore, note that after implementation of the first operational mode 50 for a predetermined number of cycles, certain small droplets will merge and combine with other droplets, resulting in slightly larger droplets that may be effectively transported during the second operational mode 52.

The electrode activation pattern or geometric wave represented by the second operational mode 52 may be operated for a predetermined time interval (e.g., on the order 100's of microseconds to 100's of milliseconds) during which the operational sub-modes 60-66 are cycled through. Each operational sub-mode 60-66 may be sustained for a time interval that is a subset of the overall time interval during which the second operational mode 52 is run.

After the second operational mode 52, a third operational mode 54 is entered. The third operational mode 54 is characterized by a period-6 electrode activation pattern, and includes six sub-modes, of which two 68, 70 (3.1, 3.2) are shown for illustrative purposes.

In the first sub-mode 68 (3.1), the first three drive electrodes (1-3) are activated (i.e., set to a high voltage state), while the adjacent three drive electrodes (4-6) are deactivated (e.g., set to 0V). In the second sub-mode 70 (3.2) the pattern is shifted to the right (or left) by one electrode, and the process continues for six steps per geometric wave. Sub-modes 68, 70 of the third operational mode 54 may repeat for a predetermined number of cycles depending upon the duration selected for the third operational mode 54 and durations for individual sub-modes 68, 70.

The third operational mode 54 may be suitable for efficiently transporting relatively large droplets occurring after implementation of the prior operational modes 50, 52.

Note that while three example operational modes 50-54 are shown, that in practice, several additional operational modes may be included (e.g., a period-eight mode, a period-ten mode, and so on), as needed to meet the needs of a given implementation.

Furthermore, note that after completion of a predetermined number of operational modes (e.g., modes 50-54), that the operational mode may return to the first mode 50, and an overall cycle of repeating modes and sub-modes may continue. Furthermore, such cycling between modes 50-54 may represent a larger geometric wave that includes sub-waves represented by the electrode activation patterns of each mode 50-54.

In certain implementations, such cycling may be determined via a hardware algorithm encoded via a finite state machine or via another controller circuit or mechanism. In other embodiments, different operational modes 50-54 are selected and/or sequentially activated in accordance with a sensed fog state on an optic surface. For example, if a fog sensor (e.g., the fog sensor 20 of FIG. 1 or the EW circuit itself) determines that only relatively large droplets remain on the surface of an optic, the third operational mode 54 may be activated (e.g., as opposed to the first operational mode 50).

Note that exact time intervals associated with different operational modes 50-54 and sub-modes 56-70 are implementation specific and may vary. Those skilled in the art with access to the present teachings may readily determine appropriate activation time intervals for various operational modes and sub-modes to meet the needs of a given implementation, without undue experimentation.

Furthermore, note that while each of the sub-modes 56-70 are shown as using similar high voltage levels for electrode activations, that the voltage levels applied during the different sub-modes 56-70 may be selectively varied between sub-modes, without departing from the scope of the present teachings. For example, the first operational mode 50 may include activation states characterized by 40V, whereas the second operational mode 52 may include activation states characterized by 60V, and so on. Exact activation-state voltages for different sub-modes 56-70 are implementation specific and may vary depending upon the needs of a given implementation.

In summary, the first operational mode 50 is characterized by a first geometric period of 2 electrodes, which is activated for a relatively short time interval. During this time interval, the geometric waveform pattern is incrementally shifted (right or left) N times (e.g., shifted one time for each of the N electrodes). The temporal shifting frequency can be, for example, 1 Hz to 1 kHz.

Afterward, a similar process is used for the next geometric period, e.g., for geometric period 4 electrodes (corresponding to the second operational mode 52), and the process continues in this manner. Note that subsequent phases or states (corresponding to sub-modes) are shown as shifted by one electrode from the prior sub-mode. The geometric period can be increased in accordance with droplet size.

In the present example embodiment, the geometric period of the EW waveform (also called electrode activation pattern) is on the order of the size of the droplets to be transported, so as to efficiently translate the droplets across the optic surface. Accordingly, to remove fog droplets of various sizes, EW circuit drive electrodes can be activated individually and/or in groups so that a geometric waveform virtual period can be generated to mimic a range of electrode pitches to efficiently match the surface fog droplet sizes as they change and/or coalesce.

Geometric waves or electrode activation patterns as discussed herein can be used in combination with various methods to meet the needs of different implementations. For example, a first method may include running a continuous geometric waveform (regardless of presence of surface fogging) that regularly cycles and varies geometric waveform periodicity. Such a method could be manually activated on-demand, e.g., via an on/off switch, for a sufficient duration to remove fog from an optic surface.

A second method includes use of capacitive electrode sensing of droplet presence and size to determine when to activate the first method described above, with termination automatically occurring with detection of a cleared surface, e.g., defogged optic surface. The capacitive electrode sensing may involve use of the same EW circuit electrodes used to remove fog to also measure optic obscuration, e.g., by sending a signal through the circuit and measuring the responsive output signal. Fog on the surface of the optic can alter the transfer function of the EW circuit, where such alterations can be mapped to different fog levels, the levels of which can in turn be selectively associated with different driving geometric waveforms.

A third example method includes detecting droplet presence via another type of sensing modality (e.g., other than use of the EW circuit electrodes themselves), such as a imaging or light scattering detector, the sensing of which may be used to selectively activate the first method described above, until fog droplets have been removed from optic surface.

A fourth example method includes use of the second or third methods indicated above in combination with added control management for controlling EW circuit activity. For example, the control management may adjust the geometric waveform periodicity based upon output signals from a droplet-sensing subsystem that provides information of the fogging droplet size as well as presence or absence of fog on the optic surface. For example, different fog-level thresholds may be associated with a specialized geometric waveform.

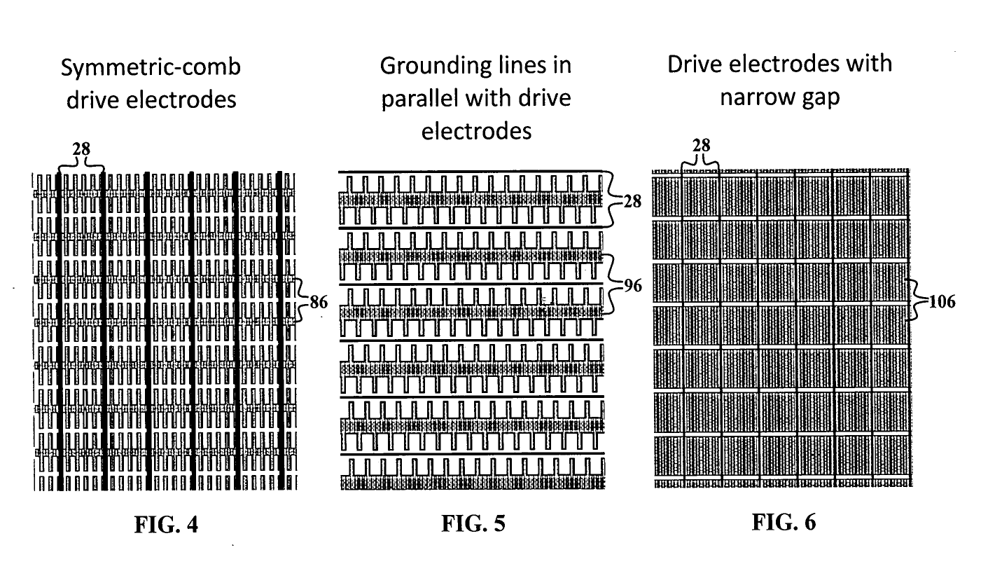

FIG. 4 shows a second example EW circuit electrode pattern 28, 86, suitable for use with the EW circuit of FIG. 1, and which includes drive electrodes 86 exhibiting a symmetric comb pattern. Ground electrodes 28 run approximately perpendicular to the symmetric-comb drive electrodes 86. Note that ground electrodes 28 may be angled differently (e.g., other than 90 degrees) relative to the drive electrodes 86, without departing from the scope of the present teachings.

FIG. 5 shows a third example EW circuit electrode pattern 28, 96, which includes drive electrodes 96 exhibiting a staggered comb pattern of drive electrodes 86, with ground electrodes 28 that are interspersed with and that run parallel to the staggered-comb drive electrodes 96.

FIG. 6 shows a fourth example EW circuit electrode pattern 28, 106, which includes drive electrodes 106 exhibiting relatively narrow spacing gaps (relative to line widths of the drive electrodes 106). The ground electrodes 28 run approximately perpendicular to the drive electrodes 106.

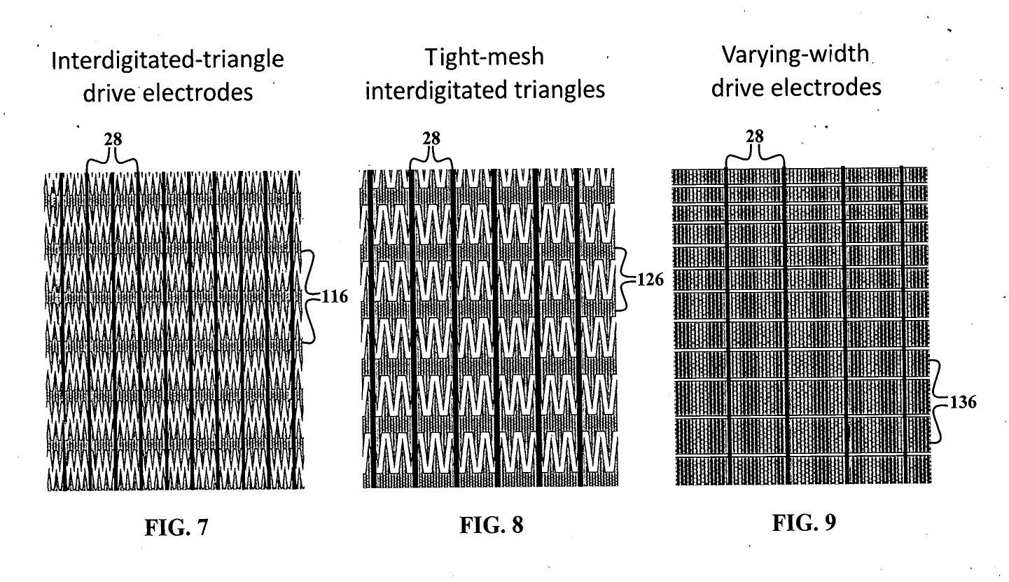

FIG. 7 shows a sixth example EW circuit electrode pattern 28, 116, which includes drive electrodes 116 exhibiting interdigitated triangles. The interdigitated-triangle electrodes 116 may enable concentration of electric fields near the tips of triangles of the interdigitated-triangle electrodes 116.

FIG. 8 shows a seventh example EW circuit electrode pattern 28, 126, which includes drive electrodes 126 exhibiting tight-mesh interdigitated triangles. The ground electrodes 28 run approximately perpendicular to the tight-mesh-interdigitated drive electrodes 126.

FIG. 9 shows an eighth example EW circuit electrode pattern 28, 136, which includes drive electrodes 136 exhibiting a graduated linewidth pattern. Such a pattern may be particularly useful for vertical surfaces, where larger droplets tend to accumulate at lower portions of the surfaces to be defogged.

Note that various features of the various EW circuit electrode patterns of FIGS. 2, 4-9 may be interchanged without departing from the scope of the present teachings. For example, the interdigitated-triangle drive electrodes 116 of FIG. 7 may exhibit increasing widths, similar to the increasing widths of the drive electrodes 136 of FIG. 9, without departing from the scope of the present teachings.

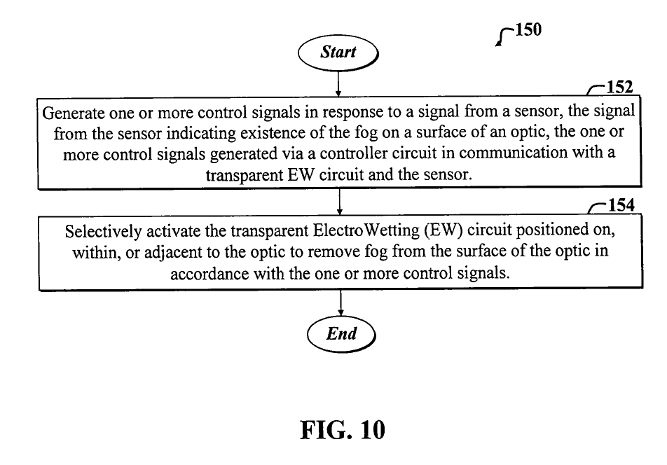

FIG. 10 is a flow diagram of a first example method 150 suitable for use with the system 14 of FIG. 1. The example anti-fog method 150 facilitates removal of condensation from a surface, such as an optic surface.

With reference to FIGS. 1 and 3, the example method 150 includes a first step 152, which involves generating one or more control signals (also called circuit driving waveforms) in response to a signal from a sensor (e.g., the sensor 20 of FIG. 1 or a sensor implemented synergistically using electrodes of the EW circuit 16); the signal from the sensor 20 indicating existence of (or a likelihood of) fog on the surface of the optic 12; the one or more control signals generated via a controller circuit (e.g., controller 18 of FIG. 1) in communication with an transparent EW circuit (e.g., EW circuit 16 of FIG. 1) and the sensor 20.

A second step 154 includes activating the transparent EW circuit 18, which is positioned on, within, or adjacent to the optic 12, to remove fog from a surface of the optic 12 in accordance with the one or more control signals issued by the EW controller 18.

Note that the method 150 may be modified without departing from the scope of the present teachings. For example, embodiments need not employ a fog sensor. As another example, the method 150 may be further augmented to specify that the transparent EW circuit 16 includes a microfluidic transparent EW circuit.

The fog sensor 20 of FIG. 1 may be adapted to detect condensation or fog on the optic surface and generate a signal in response thereto. The computer code may include instructions for selectively activating the transparent microfluidic EW circuit 16 based on the signal.

Note that the term “computer code” may refer to any instructions readable by a computer, which may be any processor in communication with a memory. Examples of computer code include instructions encoded via a Hardware Description Language (HDL) used with Field-Programmable Gate Arrays (FPGAs), Application-Specific Integrated Circuits (ASICs), and so on.

The method 150 may be further augmented to specify, for example, that the optic surface is a non-PCB surface, which may include a curved surface. The transparent microfluidic EW circuit 16 may include a circuit constructed using an electrode deposition process.

The electrode deposition process may include direct write laser exposure of photoresist on the optic surface. The electrode deposition process may further include sputter coating the conductive material on a patterned resist surface to create the transparent microfluidic EW circuit 16. Electroplating processes may also be used.

The surface of the optic may include a flexible skin that accommodates the transparent EW circuit 16 thereon or therein. An insulating dielectric layer may substantially cover one or more electrodes of the transparent EW circuit 16.

The insulating dielectric may include a sputtered, deposited or grown material, or stack-up of such materials, and for example, may include materials such as Parylene, silicon dioxide, PTFE (polytetrafluoroethylene) hydrophobic layer, and/or elastomeric materials, e.g., silicone, Poly DiMethyl Siloxane (PDMS). The flexible membrane skin may be disposed on an optic substrate that includes a polymer or glass.

The EW circuit 16 may alternatively be constructed using roll-to-roll microprinting techniques to pattern the transparent EW circuit 16 on the flexible skin for later transfer to the optic surface 12. A surface of the flexible EW skin may represent or be applied on the surface of the optic 12.

Manufacturing the EW circuit 16 may also be performed with a set of conformal masks. These masks may allow the selective exposure of photoresist, and indirectly, the patterning of the EW circuit 16 on the optic surface 12. In the MEMS field, masks are often used to pattern conductive or non-conductive features on a substrate. Note that the above example techniques for forming the EW circuit 16 may be replaced with other techniques, without departing from the scope of the present teachings.

For the purposes of the present discussion, a conformal mask may be a tool for implementing a method that involves lithographically printing electrodes on a curved surface. An example conformal mask can be made from a soft and/or springy material, e.g., Parylene and or silicone (or some other material as known in the art). The conformal mask may work in different modes. For example, a first mode may involve optical masking, wherein light energy is either masked or let through depending on the type of photoresist (positive or negative) used to pattern the electrode layer(s). A second example mode may involve soft lithography similar to “micro contact printing,” wherein relief patterns on the surface of the conformal mask form patterns of Self-Assembled Monolayers (SAMs) of ink (or resist-like material) on an optic surface through conformal contact.

In the present example embodiment, the transparent EW circuit 12 may include one or more transparent electrodes with line widths under approximately fifty micrometers. The one or more transparent electrodes may include graphene, Indium-Tin Oxide (ITO), carbon nano-tubes (CNTs), and conductive elastomer or polymers.

The example method 150 may be further augmented to specify that the transparent EW circuit 16 includes an interdigitated comb array. The interdigitated comb array may include dual layer electrodes in communication with a driving circuit (also called a controller) that enables selection of a particular drive state from among multiple possible drive states. The multiple possible drives states may include, for example, active, grounded, and floating states.

The transparent EW circuit 16 may exhibit complimentary push-pull topology. Furthermore, the driving circuit, i.e., controller 18, may be configured to output a driving waveform shape and phasing as a function of a pattern characterizing one or more electrodes of the interdigitated comb array. Addressing of individual electrodes and/or groups of electrodes also allows dynamically changing the waveform periodicity over the EW circuit. This dynamic change enables the ability to efficiently move droplets of various sizes.

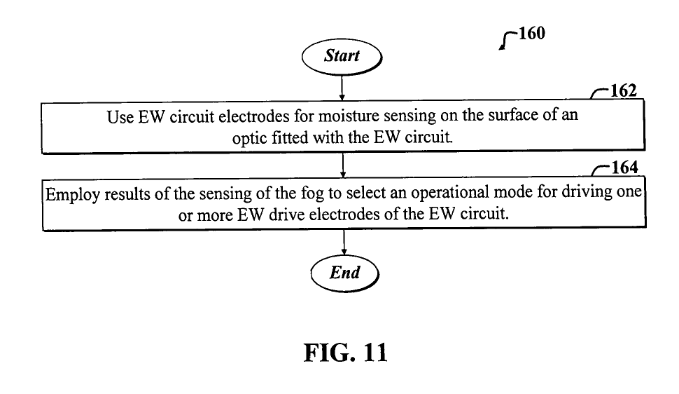

FIG. 11 is a diagram of a second example method 160 suitable for use with the system 10 of FIG. 1 for using EW circuit electrodes for surface fog sensing, which is not necessarily limited to fog sensing on optic surfaces.

The second example method includes an initial moisture-sensing step 162, which involves using EW circuit electrodes for moisture sensing on the surface of an optic fitted with the EW circuit.

A subsequent, activation step includes using results of the fog sensing to select an operational mode for driving one or more EW drive electrodes of the EW circuit.

Recall that fog on the surface of the optic or other surface can alter the transfer function of the circuit, and such alterations can be mapped to different fog levels, the levels of which can in turn be selectively associated with different driving waveforms.

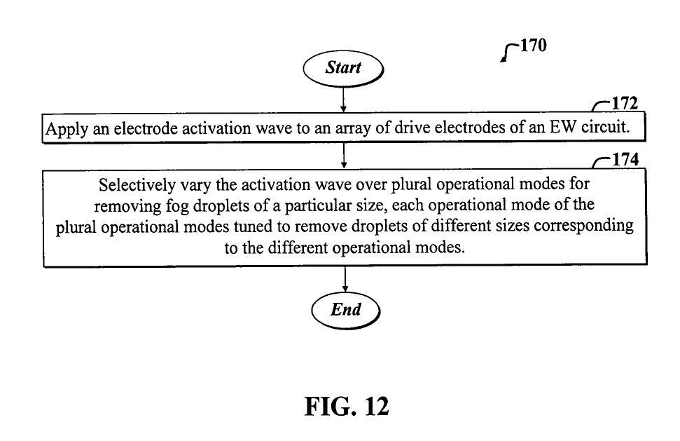

FIG. 12 is a diagram of a third example method 170 suitable for use with the embodiments of FIGS. 1 and 2 for applying an electrode activation wave to an array of drive electrodes of an EW circuit, and which is not necessarily limited to use in combination with an optic surface.

The third example method 170 includes a first electrode-activation step 172, which involves applying an electrode activation wave (also called geometric wave herein) to an array of drive electrodes of an EW circuit.

A second wave-variation step 174 includes selectively varying the electrode activation wave over plural operational modes. The different operational modes facilitate efficient removal of fog droplets of different sizes. Each operational mode of the plural operational modes may be tuned to remove droplets of different sizes corresponding to the different operational modes.

Note that electrode activations may be varied periodically and/or in accordance with a predetermined activation scheme (e.g., as may be specified using a finite state machine) or via other mechanisms, e.g., based on sensing of one or more characteristics of the droplets to be removed from a surface. For example, the periodicity of an activation wave may be varied in accordance with detected droplet size, droplet surface tension estimates, and so on.

Furthermore, the periodicity of an electrode activation wave may be varied in accordance with a predetermined cycle that specifies periodic adjustment of the periodicity of the activation wave, such that the periodicity of the activation waveform is dynamically changed to facilitate fog removal from a surface.

Note that methods other than the methods 150, 160, 170 illustrated in FIGS. 10-12 are possible. For example, another method within the scope of the present teachings includes obtaining or constructing a flexible skin (also called flexible film herein) with flexible EW circuit incorporated thereon or therein; and then electively applying an electrical signal to each drive electrode of the EW circuit to enable shuttling fog from a surface of the flexible skin, which may be affixed to an optic surface or other surface. When the flexible skin is applied to an optic surface, the flexible skin may be transparent and include a transparent EW circuit.

In certain implementations, the flexible skin and accompanying transparent EW circuit may be adjusted to provide a tint to the optic, such that the flexible skin and EW circuit act as an optic-tinting film with incorporated fog-removal functionality.

Although the description has been described with respect to particular embodiments thereof, these particular embodiments are merely illustrative, and not restrictive. For example, while various embodiments pertain to facilitating defogging of optic surfaces, embodiments are not limited thereto. For example, certain embodiments discussed herein may be employed to defog or act as an anti-fog mechanism on other types of surfaces; not just optics or curved surfaces, without departing from the scope of the present teachings.

In general various embodiments discussed herein may be adapted for various applications, including, but not limited to, scuba masks, hazardous equipment masks, water sports eyewear (e.g., swim goggles), deep sea submersible cockpits, space suit helmets, aircraft pilot helmets, motorcycle helmets, windows of automobiles and homes, mirrors, electro optical and infrared sensors, night vision devices (e.g., night sights) and goggles, rifle scopes, vehicle instrumentation for ground and aerial platforms, and so on.

Furthermore, while various embodiments discussed herein present mechanisms for actively defogging a surface, i.e., sensing when a surface is exhibiting fog and then activating EW defogging electronics in response thereto, embodiments are not limited thereto. For example, in a cyclical or non-feedback mode (e.g., without using a fogging sensor), an EW controller may periodically issue control signals to an EW defogging or anti-fog circuit regardless of whether fog accumulation is sensed, without departing from the scope of the present teachings.

As an additional example, the periodic issuing of control signals to the EW circuit 16 of FIG. 1 could be monitored by the controller 18 to infer the presence or absence of fogging on the optic surface 12 through electrical changes such as capacitance, and then to perform an appropriate defogging activity based upon the inferred presence of condensation, without departing from the scope of the present teachings.

Note that, to configure or specify instructions used by the EW controller or drive circuit 18 of FIG. 1, any suitable hardware (e.g., Field-Programmable Gate Arrays (FPGAs)), firmware, and/or software algorithms may be employed. When implementing software algorithms, any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating removal of condensation from a surface, the method comprising:
activating a transparent ElectroWetting (EW) circuit positioned on, within, or adjacent to an optic to remove fog from a surface of the optic.

2. The method of claim 1, further including generating one or more control signals in response to a signal from a sensor, the signal from the sensor indicating existence of the fog on the surface of the optic, the one or more control signals generated via a controller circuit in communication with the transparent EW circuit and the sensor.

3. The method of claim 1, wherein the transparent EW circuit includes a microfluidic transparent EW circuit.

4. The method of claim 3, further including using a fog sensor for detecting condensation on the optic surface and generating a signal in response thereto, wherein the controller implements instructions for selectively activating the transparent microfluidic EW circuit based on the signal.

5. The method of claim 3, wherein the optic surface is a non-PCB surface, wherein the non-PCB surface includes a curved optic surface.

6. The method of claim 5, wherein the transparent microfluidic EW circuit includes a circuit constructed using an electrode deposition process.

7. The method of claim 6, wherein the electrode deposition process includes write laser exposure of photoresist on the surface.

8. The method of claim 7, wherein the electrode deposition process includes sputter coating the electrode material on the surface to create the transparent microfluidic EW circuit.

9. The method of claim 6, wherein the surface of the optic includes a flexible skin accommodating the transparent microfluidic EW circuit thereon or therein.

10. The method of claim 9, further including an insulating dielectric layer substantially covering one or more drive electrodes of the transparent microfluidic EW circuit and positioned between the one or more ground electrodes and the one or more drive electrodes of the EW circuit.

11. The method of claim 10, wherein the insulating dielectric includes an elastomeric or hydrophobic film.

12. The method of claim 9, wherein the flexible skin is disposed on an optic substrate.

13. The method of claim 1, wherein the transparent EW circuit includes one or more transparent electrodes with line widths under approximately 300 micrometers.

14. The method of claim 13, wherein the one more transparent electrodes include one or more of the following types of electrodes: Indium Tin Oxide (ITO) electrodes, graphene electrodes, Carbon Nanotube electrodes, conductive polymer electrodes.

15. The method of claim 1, wherein the transparent EW circuit includes an interdigitated comb array.

16. The method of claim 15, wherein the interdigitated comb array includes dual layer electrodes in communication with driving circuit (also called a controller), enabling selection of a particular drive state from among multiple possible drive states, wherein the multiple possible drives states include active, grounded, and floating states.

17. The method of claim 16, wherein the transparent EW circuit exhibits complimentary push-pull topology, and wherein the driving circuit is configured to output a driving waveform shape and phasing as a function of a pattern characterizing one or more electrodes of the interdigitated comb array.

18. A system for facilitating removal of condensation from a surface, the system comprising:
a transparent ElectroWetting (EW) circuit positioned on or within an optic;
a controller in communication with the electrowetting circuit; and
computer code running on the controller and configured to activate the transparent EW circuit to remove condensation from a surface of the optic.

19. The system of claim 18, wherein the transparent EW circuit includes a microfluidic transparent EW circuit, and wherein the system further includes a fog sensor for detecting condensation on the optic surface and generating a signal in response thereto.

20. A system for facilitating removal of condensation from a surface, the system comprising:
first means for employing a transparent ElectroWetting (EW) circuit positioned on or within an optic to perform sensing of fog on a surface of the optic;
second means for employing the EW circuit to remove fog from the surface of the optic in accordance with results of sensing performed by the first means, the second means further including:
third means for activating one or more drive electrodes of the EW circuit according to an electrode activation pattern, the electrode activation pattern selected in accordance with the results of the sensing.
